(19) United States
(12) Patent Application Publication
(10) Pub. No.: US 2007/0045353 A1
(43) Pub. Date: Mar. 1, 2007

(54) Fluid line assembly tool

(75) Inventors: Todd Palmer Davis, Dublin, PA (US); Marko Konstantin Lubic, Shillington, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: R&B, Inc., Colmar, PA (US)

(21) Appl. No.: 11/214,183

(22) Filed: Aug. 29, 2005

(51) Int. Cl. B67D 5/42

(52) U.S. Cl. 222/391

(57) ABSTRACT

An assembly tool for assembling a fluid line. The tool comprises a handle having a mounting face and a drive mechanism. A first holder connected to the draw bar clamps a fluid line in position along a longitudinal axis spaced apart from the draw bar. A second holder holds a fluid line or a fitting in position along the longitudinal axis. The drive mechanism is manually or electronically actuatable to draw the first holder and draw bar towards the handle.

### FIELD OF INVENTION

The present invention relates to assembly tools. More particularly, the present invention relates to an assembly tool for fabricating or repairing fluid lines. Still more particularly, the invention relates to the assembly of fluid lines for motor vehicles.

### BACKGROUND

Fluid lines typically require a variety of tools and a great deal of effort to fabricate. At a minimum, a clamping tool is needed to securely hold the line in place while another tool is used to insert a second component into the line. Existing line fabrication tools are similar in concept and design to a typical caulking gun. One such tool is the K-Line® AT3610 Nylon Fuel Line Fitting Connector Tool. K-Line's® AT3610 is basically a caulk gun modified to include a series of sub-assemblies for holding a fitting and driving it into fuel line. Each time a different fuel line or fitting is required, one or more of these sub-assemblies must be modified or interchanged to accommodate the variation(s). Since modifying and interchanging these sub-assemblies requires additional tools, line assembling with these caulk-gun-like tools can consume large amounts of time and effort.

Accordingly, it is desirable to have a tool that is easily adaptable to fittings and fluid lines of various shapes and sizes and requires minimal time and effort to arrange and implement.

### SUMMARY

The present invention is a tool for assembling a fluid line. The tool comprises a handle having a mounting face and a drive mechanism, a draw bar, a first holder, and a second holder. The first holder is connected to the draw bar and clamps a work piece in position along a longitudinal axis. The second holder holds a work piece in position with the longitudinal axis. The drive mechanism draws the first and second holders towards each other and assembles the work pieces.

### BRIEF DESCRIPTION OF THE DRAWINGS

A more detailed understanding of the invention may be had from the following description of the preferred embodiments, given by way of example and to be understood in conjunction with the accompanying drawings wherein:

FIG. 1 is a perspective of a fluid line assembly tool;

FIG. 2 is an exploded perspective of the tool of FIG. 1;

FIG. 3 is a perspective of a holder adapted to secure a fluid line;

FIG. 4 is an exploded perspective of the holder of FIG. 3;

FIG. 5 is a perspective of a holder adapted to secure straight fittings;

FIG. 6 is an exploded perspective of the holder of FIG. 5;

FIG. 7 is a rear perspective of the holder of FIG. 5;

FIG. 8 is a perspective of a holder adapted to secure elbow fittings;

FIG. 9 is an exploded perspective of the holder of FIG. 8;

FIG. 10 is a rear perspective of a portion of the holder of FIG. 8;

FIG. 11 is a cradling insert for use with the holder of FIG. 8;

FIG. 12 is a perspective of another holder adapted to secure a fluid line;

FIG. 13 is an exploded perspective of the holder of FIG. 12; and

FIG. 14 is a rear perspective of a portion of the holder of FIG. 12.

### DETAILED DESCRIPTION OF THE PREFERRED EMBODIMENTS

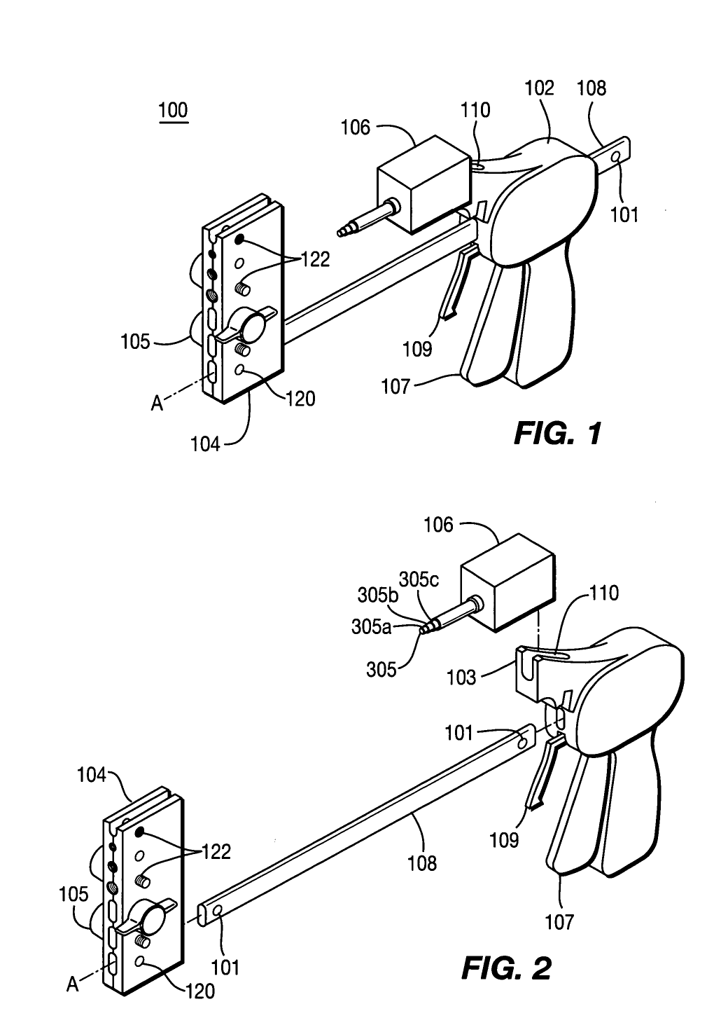

Referring to FIGS. 1 and 2, an assembly tool 100 in accordance with the present invention is shown. The assembly tool 100 comprises a handle 102, a draw bar 108, a first holder 104 connected to the draw bar 108, and a second holder 106 adjacent to the handle 102. The handle 102 has a mounting face 103 for receiving the second holder 106 and a drive mechanism (not shown), such as the type used in a caulk gun, for drawing the draw bar 108 towards the handle 102. In a preferred implementation, the drive mechanism draws an open end of a fluid line secured in the first holder 104 over barbs of a fitting secured on the second holder 106 until the barbs are inserted into the fluid line. In a manually-driven embodiment, the drive mechanism is actuated by repeatedly squeezing the trigger 107. Alternatively, the drive mechanism may be power driven, in which case the mechanism may be actuated by depressing and holding the trigger 107. To reset the draw bar 108, the release lever 109 is depressed, and the draw bar 108 is freed to move back to its pre-draw position.

The first holder 104 is preferably connected to the draw bar 108 with an appropriate fastening means, such as with a thumb screw 105, through an aperture 101 in the draw bar 108. The thumb screw 105 is preferably extended through a non-threaded opening 120 in the portion of the first holder 104 positioned on one side of the draw bar aperture 101 until it passes through the draw bar aperture 101 and engages a threaded aperture 122 in the portion of the first holder positioned on the opposite side of the draw bar aperture 101. When connected, the holder 104 is positioned along a longitudinal axis A. The second holder 106 is mounted to the mounting face 103 in position with the longitudinal axis A and aligned with a desired location on the first holder 104.

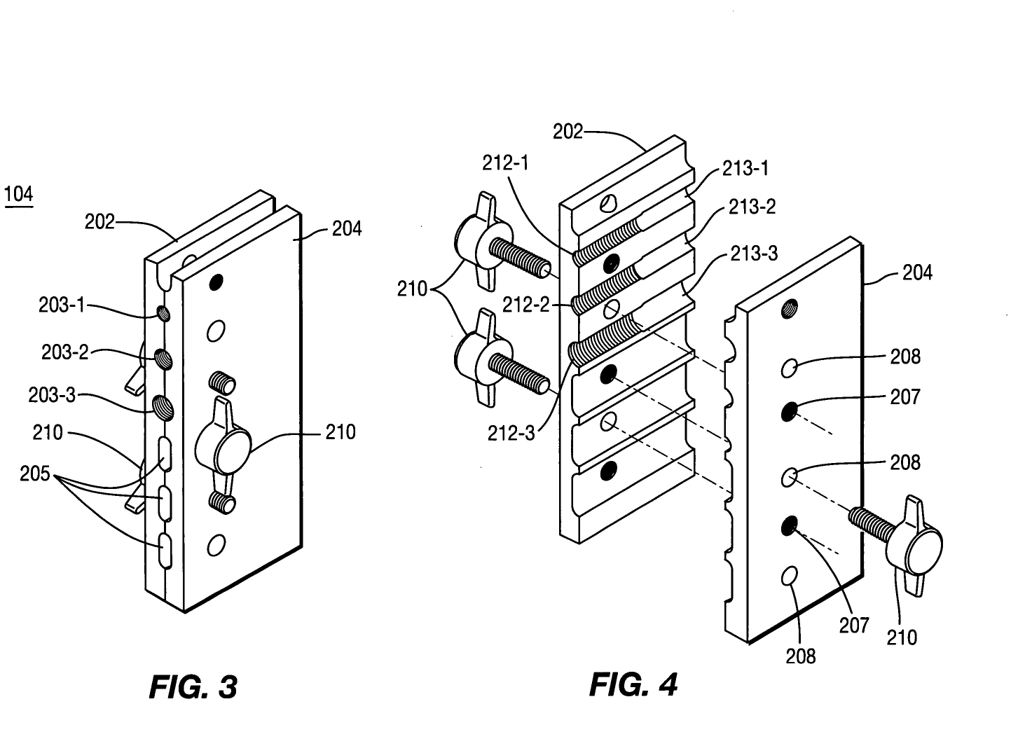

In a preferred embodiment, the first holder 104, as illustrated in FIGS. 3 and 4, is configured to secure fluid lines of various sizes. This first holder 104 comprises opposed blocks 202, 204. When secured together, these blocks 202, 204 define a first plurality of apertures 203-1, 203-2, 203-3 for securing fluid lines and a second plurality of apertures 205 for positioning the holder 104 on the draw bar 108.

Each of the first plurality of apertures 203-1, 203-2, 203-3 is generally circular and has a different diameter for securing a particularly-sized fluid line. A portion of each aperture 203-1, 203-1, 203-1 is grooved at 212-1, 212-2, 212-3, respectively, to provide a gripping surface for securing a line. These grooves 212-1, 212-2, 212-3 provide a uniform compression means that firmly secures the line without crushing or deforming it. The non-grooved portions 213-1, 213-2, 213-3 of the apertures 203-1, 203-2, 203-3 have a slightly larger diameter than the grooved portions 212-1, 212-2, 212-3. These enlarged portions 213-1, 213-2, 213-3 provide room for a secured line to expand while being drawn over the barbs of a fitting.

The second plurality of apertures 205 define complementary openings that receive the draw bar 108. These apertures 205 are used to selectively secure the first holder 104 to the draw bar 108 in a desired vertical position relative to the line-securing apertures 203-1, 203-2, 203-3 about the longitudinal axis A and aligned with the second holder 106.

The line-securing blocks 202, 204 may be secured together by any appropriate means, such as with the thumb screws 210 shown in FIGS. 3 and 4. Each thumb screw 210 is first extended through a non-threaded aperture 208 in one of the blocks 202, 204 and then engaged in an aligned threaded aperture 207 in the other of the blocks 202, 204. Although illustrated with a particular configuration, it should be noted that the threaded and non-threaded apertures 207, 208 in the blocks 202, 204 may be arranged in any desired configuration.

Tightening the thumb screws 210 provides the means for securing a line in one of the line-securing apertures 203-1, 203-2, 203-3. The thumb screws 210 may have fully threaded shafts, as shown in FIGS. 3 and 4, or partially threaded shafts, whereby shoulder stops on the thumb screws may be utilized in providing the securing means. By utilizing a securing means such as thumb screws 210, the line holder 104 may be adapted to secure differently sized lines without requiring the use of additional tools.

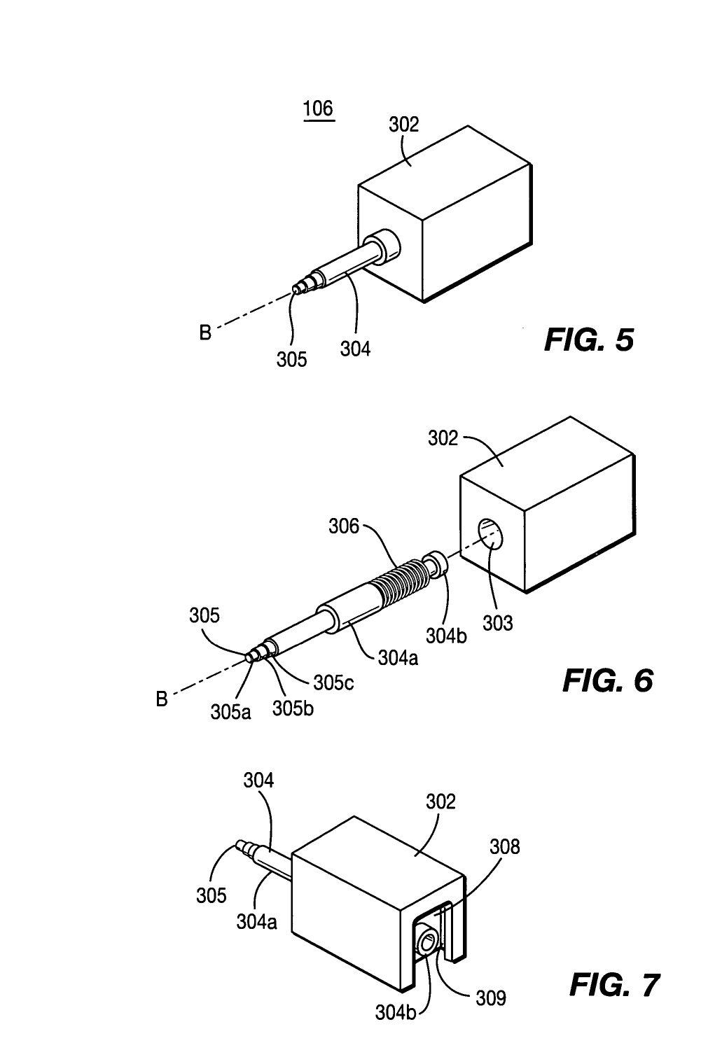

Referring now to FIGS. 5, 6, and 7, various perspectives of the second holder 106 adapted to secure straight fittings are illustrated. This second holder 106 comprises a block chassis 302 having a longitudinal axis B, and a mandrel 304 extending from the chassis 302 along the longitudinal axis B. In a preferred embodiment, the mandrel 304 has a multi-tiered mandrel tip 305 for securing fittings of various sizes and has a spring 306 to provide flex and shock-absorption in the mandrel when securing the fittings. Each tier 305a, 305b, 305c on the mandrel tip 305 is sized to securely snap into a fitting of a different size. Although illustrated as having three tiers 305a, 305b, 305c, it should be understood that the mandrel tip 305 may be configured with any desired number of tiers. The mandrel spring 306 is set between the body 304a of the mandrel 304 and the mandrel bolt 304b, whereby the spring 306 rests against an interior surface of a rear wall 308 of the block chassis 302 slightly compressed by the bolt 304b residing on an outside surface of the rear wall 308.

The rear portion of the second holder 106 defines a complementary mounting slot 309 for receiving the mounting face 103, thereby providing a means for securely attaching the second holder 106 to the tool handle 102 without requiring the use of additional tools.

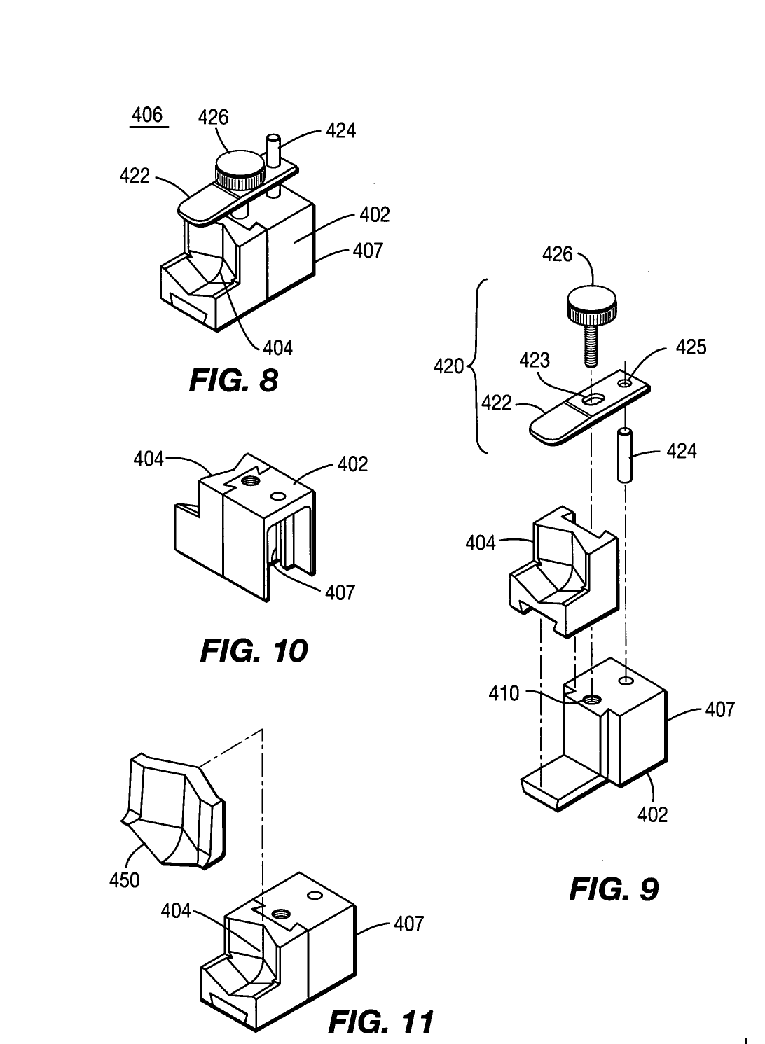

An alternate second holder 406, illustrated in FIGS. 8, 9, and 10, is adapted to hold elbow-type fittings. This elbow-fitting-adapted second holder 406 comprises a rear portion 402, a cradling portion 404 for holding an elbowed fitting, and a clamping mechanism 420 for securing an elbow fitting in the cradling portion 404

The rear portion 402 of the holder 406 is preferably an angle block that defines a complementary mounting slot 407 that receives a mounting face 103, which provided a means for securely connecting the second holder 406 to the tool handle 102 without requiring the use of additional tools.

The cradling portion 404 of the second holder 406 is preferably composed of a non-slip, resilient material, such as urethane rubber with a derometer measurement of 95 Shore A, and has a contoured inside surface that forms a cradling pocket for holding elbowed fittings in position aligned with the first holder 104.

The clamping mechanism 420 of the holder 406 preferably comprises an angled clamp plate 422, a guide dowel 424, and a tightening means, such as a thumb screw 426.

An elbowed fitting is secured in the holder 406 by first placing the fitting in the cradling portion 404. The clamp plate 422 is then slid over the guide dowel 424 through an aperture 425 in the clamp plate 422 until a front portion of the clamp plate 422 contacts the fitting. In a preferred embodiment, the front portion of the clamp plate 422 is angled downwardly to urge the fitting into the cradling portion 404. Once the fitting and clamp plate 422 are in position, the thumb screw 426 is passed through aperture 423 and engaged in the threaded aperture 410. The height, and hence, the amount of compression exerted on the clamp plate 422 is adjusted along the dowel 424 by tightening and loosening the thumb screw 426.

For securing smaller elbow fittings, a cradling insert 450 may optionally be inserted into the cradle portion 404 of the second holder 406, as illustrated in FIG. 11. The cradling insert 450 is contoured similarly to the inside surface of the cradling portion 404 and allows relatively short fittings to protrude beyond the cradle portion 404.

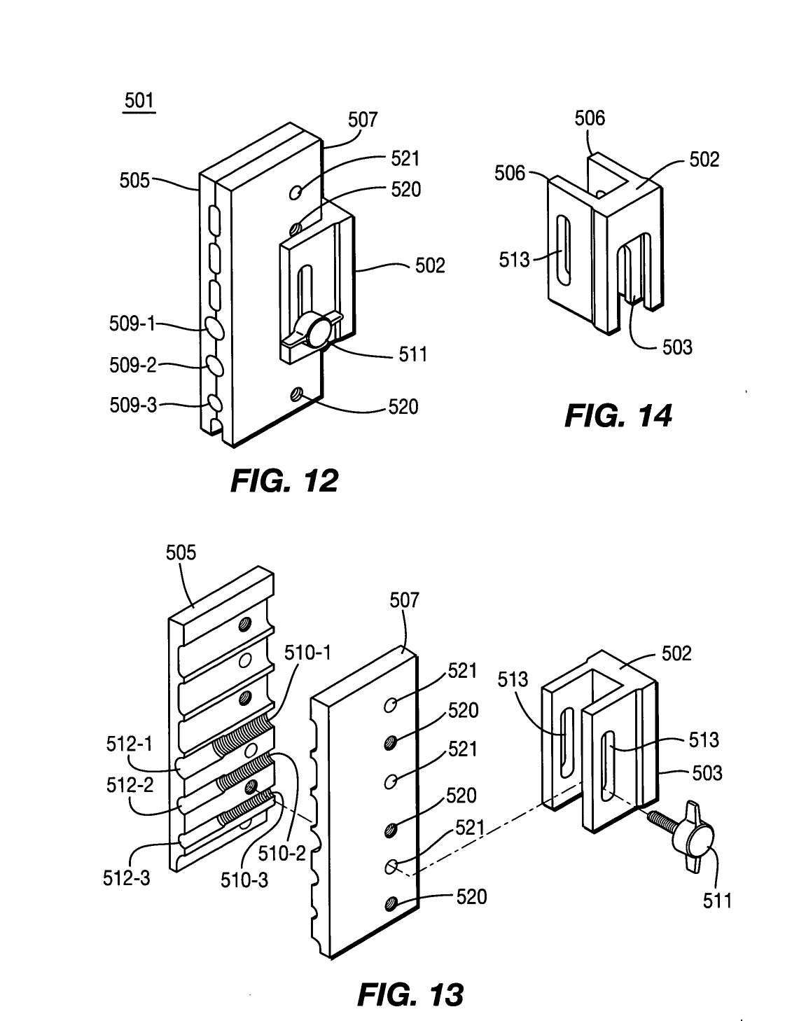

Referring now to FIGS. 12, 13, and 14, various perspectives of another holder 501 adapted to secure fluid lines are illustrated. This holder 501 comprises line-securing blocks 505, 507 and a rear portion 502 that defines a complementary mounting slot 503 for receiving the mounting face 103. The mounting slot 503 provides a means for securely connecting the rear portion 502 of the holder 501 to the tool handle 102.

The rear portion 502 comprises a U-shaped bracket having opposed lateral sides 506. These lateral sides 506 define at least one aperture 513 for securing the line-securing blocks 505, 507 to the rear portion 502 in a desired position aligned with the first holder 104. The blocks 505, 507 are opposed and when secured together, such as with a thumb screw 511, as previously described, the blocks 505, 507 define a plurality of generally circular apertures 509-1, 509-2, 509-3 for securing fluid lines of various sizes. A portion of each aperture 509-1, 509-2, 509-3 is grooved at 510-1, 510-2, 510-3, respectively, to provide a gripping surface for securing a fluid line to be fitted with a fitting. These grooves 510-1, 510-2, 510-3 provide a uniform compression means that firmly secures a line without crushing or deforming it. The non-grooved portions 512-1, 512-2, 512-3 of the apertures have a slightly larger diameter than the grooved portions 510-1, 510-2, 510-3. These enlarged portions 512-1, 512-2, 512-3 provide room for a secured line to expand while being drawn over the barbs of a fitting.

Referring now to FIGS. 2 and 14, the mounting slot 503 of the rear portion 502 of the holder 501 and the mounting face 103 of the tool handle 102 preferably combine to provide a securing means for a fluid line. By partially inserting the mounting face 103 into the mounting slot 503, an upper portion of the mounting slot 503 and a groove 110 defined by the rear portion 502 combine to define a channel. A fluid line may be secured in this channel by positioning the line in the groove 110 and fully inserting the mounting face 103 into the mounting slot 503.

It should be noted that the various embodiments of the second holders described above are preferably interchangeable with one another. Further, since each adapter has a mounting slot for slidedly engaging the mounting face 103, no additional tools are required to interchange these holders.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A fluid line assembly tool comprising:
a handle having a mounting face and a drive mechanism;
a draw bar that is engaged with the drive mechanism;
a first holder that is connected to the draw bar in a position opposite to and spaced from the handle; and
a second holder that is attached to the mounting face opposite the first holder;
whereby actuation of the drive mechanism draws the first and second holders toward each other.

2. The assembly tool of claim 1, wherein the first holder comprises:
a block assembly having opposed first and second blocks positioned parallel to each other, said blocks defining at least a first aperture for securing a fluid line and at least a second aperture for securing said block assembly to the draw bar; and
a compression means for securing the two blocks together.

3. The assembly tool of claim 2, wherein the compression means for securing the two blocks together comprises:
at least one threaded aperture in one of the first and second blocks and an aligned non-threaded aperture in the other of the first and second blocks; and
a thumb screw extending through the non-threaded aperture and engaging in the threaded aperture.

4. The assembly tool of claim 2, wherein a portion of the at least first aperture for holding a fluid line is generally circular and grooved and has a diameter that complements a diameter of a fluid line to be secured; wherein a non-grooved portion of the at least first aperture has a diameter slightly larger than the diameter of said grooved portion; and wherein the at least second aperture defines an area that complements a cross-sectional area of the draw bar.

5. The assembly tool of claim 4, wherein the first holder is secured to the draw bar through an aperture in said draw bar in a vertical position with the at least first fluid line-holding aperture centered about a longitudinal axis and aligned with the second holder.

6. The assembly tool of claim 5, wherein the first holder is secured to the draw bar with a securing means, said securing means comprising:
a threaded aperture in one of the first and second blocks positioned on one side of the draw bar aperture and an aligned non-threaded aperture in the other of the first and second blocks positioned on an opposite side of the draw bar aperture; and
a thumb screw extending through the non-threaded and draw bar pertures and engaging in the threaded aperture.

7. The assembly tool of claim 1, wherein the second holder further comprises:
a block chassis having a common longitudinal axis with the first holder and a rear portion; and
a mandrel for securing straight fittings, said mandrel extending from the block chassis toward the first holder along the longitudinal axis.

8. The assembly tool of claim 7, wherein the rear portion of the block chassis defines a complementary mounting slot for receiving the mounting face.

9. The assembly tool of claim 8, wherein the mandrel is nestled in an opening in the block chassis and further comprises:
a spring positioned on a rear portion of the mandrel; and
a multi-tiered mandrel tip, wherein each tier is adapted to securely snap into a differently sized fitting.

10. The assembly tool of claim 1, wherein the second holder further comprises:
a cradling portion having a common longitudinal axis with the first holder;
a clamping mechanism for securing a fitting in the cradling portion; and
a rear portion.

11. The assembly tool of claim 10, wherein the cradling portion is contoured to hold elbow fittings and is comprised of a resilient material for providing a non-slip cradling surface.

12. The assembly tool of claim 11, wherein the second holder further comprises a cradling insert adapted to securely fit into the cradling portion for holding small-sized elbow fittings.

13. The assembly tool of claim 12, wherein the cradling insert is comprised of a resilient material for providing a non-slip cradling surface.

14. The assembly tool of claim 10, wherein the clamping mechanism comprises:
a clamping plate; and
means for tightening and loosening the clamp plate.

15. The assembly tool of claim 14, wherein the tightening and loosening means comprises a thumb screw extending through an opening in the clamping plate and engaging a threaded aperture in the second holder.

16. The assembly tool of claim 10, wherein the rear portion of the second holder further comprises a complementary mounting slot for receiving the mounting face.

17. The assembly tool of claim 1, wherein the second holder further comprises:
a block assembly having opposed first and second blocks positioned parallel to each other, said blocks defining at least a first aperture for securing a fluid line;
a compression means for securing the two blocks together;
a rear portion; and
a securing means for securing the block assembly to the rear portion.

18. The assembly tool of claim 17, wherein a portion of the at least first aperture for securing a fluid line is generally circular and grooved and has a diameter that complements a diameter of the fluid line to be secured; and wherein a non-grooved portion of the at least first aperture has a diameter slightly larger than the diameter of said grooved portion.

19. The assembly tool of claim 17, wherein the compression means for securing the blocks together comprises:
at least one threaded aperture in one of the first and second blocks and an aligned non-threaded aperture in the other of the first and second blocks; and
a thumb screw extending through the non-threaded aperture and engaging in the threaded aperture.

20. The assembly tool of claim 17, wherein the rear portion defines a complementary mounting slot for receiving the mounting face.

21. The assembly tool of claim 20, wherein the rear portion is a U-shaped block having opposed lateral sides, said lateral sides each defining at least one aperture for securing the block assembly to said rear portion.

22. The assembly tool of claim 21, wherein the securing means comprises:
a threaded aperture in one of the first and second blocks and an aligned non-threaded aperture in the other of the first and second blocks; and
a thumb screw extending through the at least one aperture in one of the lateral sides and through the non-threaded aperture in one of the first and second blocks and engaging the threaded aperture in the other of the first and second blocks.

23. The assembly tool of claim 22, wherein the compression means is provided by the securing means.

24. The assembly tool of claim 23, wherein the assembly tool further comprises a secondary means for securing a fluid line, said secondary means comprising:
a groove defined by a rear portion of the mounting face; and
an upper portion of the mounting slot of the second holder;
whereby the groove and upper mounting slot portion combine to define a complementary securing channel for receiving a fluid line when the second holder is attached to the mounting face.

25. The assembly tool of claim 1, wherein the handle further comprises:
a trigger for actuating said drive mechanism to draw the first and second holders towards each other; and
a release lever for freeing the draw bar once said draw bar is in a drawn position.

26. The assembly tool of claim 25, wherein the drive mechanism is actuated manually by repeatedly squeezing the trigger.

27. The assembly tool of claim 25, wherein the drive mechanism is electronically actuated by depressing and holding the trigger.

28. A fluid line assembly tool comprising:
a handle having a mounting face;
a draw bar;
a first holder that is connected to the draw bar in a position opposite and spaced from the handle;
a second holder that is attached to the mounting face opposite the first holder; and
a drive mechanism that engages the draw bar and draws the first and second holders toward each other.

29. The assembly tool of claim 28, wherein the first holder comprises:
a block assembly having opposed first and second blocks positioned parallel to each other, said blocks defining at least a first aperture for securing a fluid line and at least a second aperture for securing said block assembly to the draw bar; and
a compression means for securing the two blocks together, said compression means comprising:
at least one threaded aperture in one of the first and second blocks and an aligned non-threaded aperture in the other of the first and second blocks; and
a thumb screw extending through the non-threaded aperture and engaging in the threaded aperture.

30. The assembly tool of claim 28, wherein the second holder further comprises:
a block chassis having a common longitudinal axis with the first holder and a rear portion, said rear portion defining a complementary mounting slot for receiving the mounting face; and
a mandrel for securing straight fittings, said mandrel extending from the block chassis toward the first holder along the longitudinal axis and further comprising:
a spring positioned on a rear portion of the mandrel; and
a multi-tiered mandrel tip, wherein each tier is adapted to securely snap into a differently sized fitting.

31. The assembly tool of claim 28, wherein the second holder further comprises:
a cradling portion having a common longitudinal axis with the first holder, wherein said cradling portion is contoured to hold elbow fittings and comprised of a resilient material for providing a non-slip cradling surface;
a clamping mechanism comprising a clamping plate and a fastener for tightening and loosening the clamping plate for securing a fitting in the cradling portion; and
a rear portion defining a complementary mounting slot for receiving the mounting face.

32. The assembly tool of claim 31, wherein the second holder further comprises a cradling insert comprised of a resilient material and adapted to securely fit into the cradling portion for holding small elbow fittings.

33. The assembly tool of claim 28, wherein the second holder further comprises:
a block assembly having opposed first and second blocks positioned parallel to each other, said blocks defining at least a first aperture for securing a fluid line;
means for securing the two blocks together;
a rear portion that defines a complementary mounting slot that mates with the mounting face; and
means for securing the block assembly to the rear portion.

34. The assembly tool of claim 28, wherein the handle further comprises:
a trigger for actuating said drive mechanism to draw the first and second holders towards each other; and
a release lever for freeing the draw bar once said draw bar is in a drawn position.

35. The assembly tool of claim 34, wherein the drive mechanism is actuated manually by repeatedly squeezing the trigger.

36. The assembly tool of claim 34, wherein the drive mechanism is continuously actuated by depressing and holding the trigger.
